(19) United States
(12) Patent Application Publication
(10) Pub. No.: US 2025/0371844 A1
(43) Pub. Date: Dec. 4, 2025

(54) APPARATUS AND METHOD FOR DETECTING OBJECT OF IMAGE

(71) Applicant: Electronics and Telecommunications Research Institute, Daejeon (KR)

(72) Inventors: Do Hun KIM, Daejeon (KR); Won Jong KIM, Daejeon (KR)

(73) Assignee: Electronics and Telecommunications Research Institute, Daejeon (KR)

(21) Appl. No.: 18/955,665

(22) Filed: Nov. 21, 2024

(30) Foreign Application Priority Data
May 29, 2024 (KR) 10-2024-0070259

(51) Int. Cl. G06V 10/764; G06T 3/18

(52) U.S. Cl. CPC G06V 10/764; G06T 3/18

(57) ABSTRACT

Provided is an apparatus for detecting an object of an image, which includes: an image classification module that distinguishes an input image as a low-light image or a normal image based on a specified criterion; and a processor that overlaps anchor boxes of a plurality of images generated by performing at least one image process on an original image, which is a low-light image distinguished by the image classification module, and then performs an object detection algorithm on the overlapping anchor boxes.

### CROSS-REFERENCE TO RELATED APPLICATION

This application claims priority to and the benefit of Korean Patent Application No. 10-2024-0070259, filed on May 29, 2024, the disclosure of which is incorporated herein by reference in its entirety.

### BACKGROUND

### 1. Field of the Invention

The present invention relates to an apparatus and method for detecting an object of an image that enable improved object detection performance.

### 2. Discussion of Related Art

Generally, in low-light conditions, noise in an image causes boundaries and details of objects to be blurry, and the low contrast makes it difficult to distinguish between objects and backgrounds.

In other words, object detection performance (or object detection accuracy) is lower in images captured in low-light conditions (i.e., low-light images).

Although the object detection performance may be improved using low-light enhancement algorithms that are publicly available, the use of low-light enhancement algorithms may actually lower (or degrade) the object detection performance for normal images.

In addition, in the past, the non-maximum suppression (NMS) algorithm was applied to each of a plurality of images to initially select an anchor box having the highest confidence in each image, and then the NMS algorithm was applied to the initially selected anchor boxes again to secondarily select an anchor box having the highest confidence.

However, such an existing object detection method increases algorithm complexity because the NMS algorithm needs to be applied twice, and when the original image is a low-light image, the confidence values themselves are not high, thus leading to poor object detection performance.

Therefore, there is a need for a method of improving the object detection performance (or object detection accuracy) for low-light images while preventing the object detection performance for normal images from being lowered.

The related art of the present invention is disclosed in Korean Laid-Open Patent No. 10-2022-0026402 (published on Mar. 4, 2022).

### SUMMARY OF THE INVENTION

The present invention is directed to providing an apparatus and method for detecting an object of an image that may improve the object detection performance by detecting an object after overlapping anchor boxes of a plurality of images that are image-processed from an original image.

The technical objectives of the present invention are not limited to the above, and may be variously expanded without departing from the technical concept and field of the present invention.

According to an aspect of the present invention, there is provided an apparatus for detecting an object of an image, which includes: an image classification module that distinguishes an input image as a low-light image or a normal image based on a specified criterion; and a processor that overlaps anchor boxes of a plurality of images generated by performing at least one image process on an original image, which is a low-light image distinguished by the image classification module, and then performs an object detection algorithm on the overlapping anchor boxes.

The processor may, in order to distinguish whether the input image is a low-light image or a normal image, distinguish whether the input image is a low-light image or a normal image based on a luminance value of each pixel included in the input image through the image classification module.

The image classification module may distinguish the low-light image from the normal image according to whether the number of pixels designated as low-luminance in the input image is greater than or equal to a threshold value.

The processor may, in order to overlap the anchor boxes, generate anchor boxes for a low-light enhancement image generated by applying a low-light enhancement algorithm to the original image.

The processor may, in order to overlap the anchor boxes, generate anchor boxes for rotated images of the original image and the low-light enhancement image of the original image.

The processor may, in overlapping the anchor boxes, generate anchor boxes of the original image, the low-light enhancement image of the original image, and the rotated images for the original image and the low-light enhancement image of the original image, and overlap the generated anchor boxes.

The processor may, in order to overlap the anchor boxes of the rotated image, apply, to the anchor boxes, a reverse rotation direction and a reverse rotation angle with respect to a rotation direction and a rotation angle of the rotated image.

The processor may overlap the anchor boxes of the plurality of images and apply a non-maximum suppression (NMS) algorithm to the overlapping anchor boxes at one time, to detect an object.

The processor may select an anchor box having a highest probability of being an object based on a degree of overlap between a plurality of overlapping anchor boxes for each image through the NMS algorithm.

The processor may select an anchor box among the plurality of overlapping anchor boxes that has an intersection of union (IoU) less than a threshold value and has a maximum confidence value.

According to an aspect of the present invention, there is provided a method of detecting an object of an image, which includes: distinguishing, by a processor, an input image as a low-light image or a normal image based on a specified criterion; and overlapping, by the processor, anchor boxes of a plurality of images generated by performing at least one image process on an original image, which is a low-light image, and then performing an object detection algorithm on the overlapping anchor boxes.

In order to distinguish whether the input image is a low-light image or a normal image, the processor may distinguish whether the input image is a low-light image or a normal image based on a luminance value of each pixel included in the input image.

In the distinguishing, by the processor, of the input image as the low-light image or the normal image, the processor may distinguish the low-light image from the normal image according to whether the number of pixels designated as low-luminance in the input image is greater than or equal to a threshold value.

In order to overlap the anchor boxes, the processor may generate anchor boxes for a low-light enhancement image generated by applying a low-light enhancement algorithm to the original image.

In order to overlap the anchor boxes, the processor may generate anchor boxes for rotated images of the original image and the low-light enhancement image of the original image.

In the overlapping of the anchor boxes, the processor may generate anchor boxes of the original image, the low-light enhancement image of the original image, and the rotated images for the original image and the low-light enhancement image of the original image, and overlap the generated anchor boxes.

In order to overlap the anchor boxes of the rotated image, the processor may apply, to the anchor boxes, a reverse rotation direction and a reverse rotation angle with respect to a rotation direction and a rotation angle of the rotated image.

In the performing of the object detection algorithm, the processor may overlap the anchor boxes of the plurality of images and applies an NMS algorithm to the overlapping anchor boxes at one time, to detect an object.

In the performing of the object detection algorithm, the processor may select an anchor box having a highest probability of being an object based on a degree of overlap between a plurality of overlapping anchor boxes for each image through the NMS algorithm.

In the performing of the object detection algorithm, the processor may select an anchor box among the plurality of overlapping anchor boxes that has an (IoU less than a threshold value and has a maximum confidence value.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary schematic diagram illustrating a configuration of an apparatus for detecting an object of an image according to an embodiment of the present invention;

FIG. 2 is a flowchart for describing a method of detecting an object of an image according to a first embodiment of the present invention; and

FIG. 3 is a flowchart for describing a method of detecting an object of an image according to a second embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of an apparatus and method for detecting an object of an image according to an embodiment of the present invention will be described.

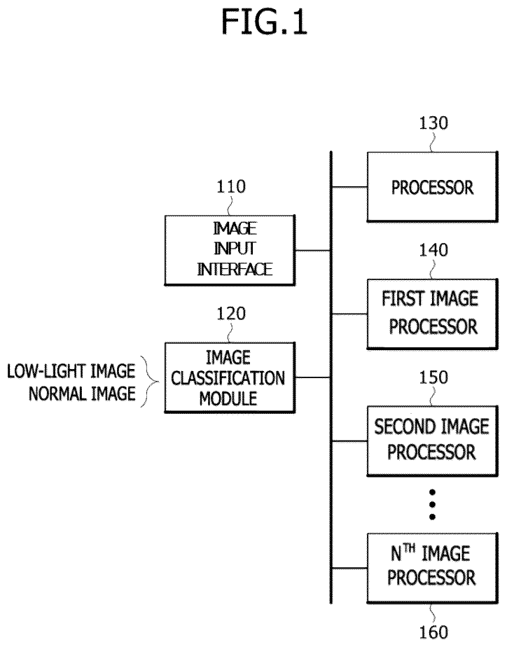

FIG. 1 is an exemplary schematic diagram illustrating a configuration of an apparatus for detecting an object of an image according to an embodiment of the present invention.

As illustrated in FIG. 1, the apparatus for detecting an object of an image according to the present embodiment includes an image input interface 110, an image classification module 120, a processor 130, a first image processor 140, a second image processor 150, and an N^{th} image processor 160.

The image input interface 110 receives an image containing an object to be detected.

The image classification module 120 may distinguish whether the input image is a low-light image or a normal image based on a specified criterion (based on whether the number of pixels designated as low-luminance in an image is greater than or equal to a threshold value).

The first image processor 140 may perform first image processing (i.e., low-light enhancement image processing using a low-light enhancement algorithm) on the low-light image (i.e., the original image) separated through the image classification module 120 to generate a low-light enhancement image.

The second image processor 150 may perform second image processing (i.e., rotation image processing using a rotation algorithm) on the low-light image (i.e., the original image) separated through the image classification module 120 and the low-light enhancement image to generate a rotated image.

In the present embodiment, a method of image processing a low-light image (i.e., the original image) using the first image processor 140 and the second image processor 150 has been described, but the present invention is not limited thereto, and additional image processing may be performed through an N^{th} image processor 160 (N is a natural number) to generate a new image.

Here, the image classification module 120 and the first image processor 140 to the N^{th} image processor 160 may be implemented by at least one separate processor, and may be integrated and implemented by the processor 130.

The processor 130 may detect an object from an input image using at least one artificial intelligence model or using a set object detection algorithm.

The processor 130 may detect an object by overlapping anchor boxes of at least one image among the plurality of images generated by the first image processor 140 to the N^{th} image processor 160 and the low-light image (i.e., the original image).

For reference, an anchor box is a box in which an object is likely to be present, and is used to detect all superimposed objects in an image. For a single image, hundreds to tens of thousands of anchor boxes may be generated.

In order to overlap the anchor box of the low-light image (i.e., the original image) or the anchor box of the low-light enhancement image and the anchor box of the rotated image generated through the second image processor 150, the processor 130 may apply, to the anchor box, a reverse rotation direction and a reverse rotation angle with respect to a rotation direction and a rotation angle of the rotated image.

For example, when the low-light image (i.e., the original image) is rotated +90 degrees to generate a rotated image, the processor 130 rotates the anchor box of the rotated image −90 degrees and then overlaps the rotated anchor box of the rotated image and the anchor box of the low-light image (i.e., the original image).

The processor 130 may apply an object detection algorithm to each image (e.g., the low-light image, the low-light enhancement image, and the rotated image) to generate a plurality of anchor boxes for detecting an object included in each image.

The processor 130 selects one anchor box having the highest probability of being an object using the degree of overlap (i.e., intersection of union (IoU) or confidence of a specific anchor box) between a plurality of anchor boxes in each image through the non-maximum suppression (NMS) algorithm.

Here, the confidence represents information about the possibility that an object is included in an anchor box.

For example, the processor 130 may select one anchor box having an IoU less than a threshold value and having the maximum confidence value among a plurality of anchor boxes in each image through the NMS algorithm.

Meanwhile, even for anchor boxes for the same object in one image, anchor boxes with different confidence values may be selected in a low-light image and a low-light enhancement image. That is, even when a low-light image is subjected to low-light enhancement by the low-light enhancement algorithm, the object detection performance (or object detection accuracy) may decrease.

For example, compared to the low-light image, an anchor box with a relatively high confidence value may be present in the low-light enhancement image. Alternatively, compared to the low-light enhancement image, an anchor box with a relatively high confidence value may be present in the low-light image.

Therefore, the present embodiment provides a method of improving the object detection performance (or object detection accuracy) for the low-light image.

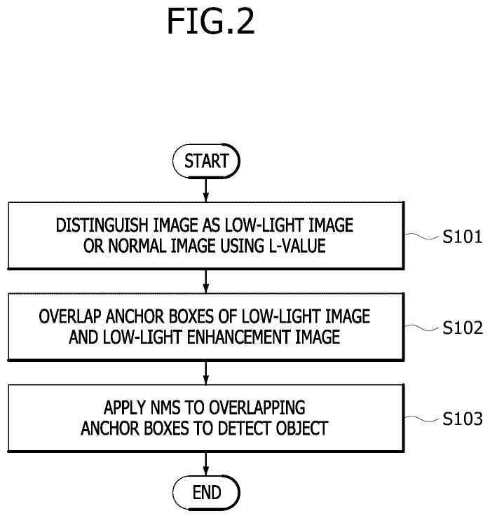

FIG. 2 is a flowchart for describing a method of detecting an object of an image according to a first embodiment of the present invention.

Referring to FIG. 2, the processor 130 uses an L-value value (i.e., a luminance value of each pixel included in the image or a value indicating whether the number of pixels corresponding to low-luminance is greater than or equal to a threshold value) to distinguish whether the input image is a low-light image or a normal image (S101).

For example, the processor 130 may calculate a luminance value score of all pixels included in the image, and may distinguish whether the input image is a low-light image or a normal image based on whether the score is greater than or equal to a threshold value.

The processor 130 may obtain (generate) a low-light enhancement image by applying a low-light enhancement algorithm to the low-light image (original image).

The processor 130 may generate anchor boxes of the low-light image (original image) and anchor boxes of the low-light enhancement image and allow the anchor boxes of the low-light image to overlap the anchor boxes of the low-light enhancement image (S102).

In this case, the anchor boxes of each image (e.g., the low-light image and the low-light enhancement image) may have different confidence values.

The processor 130 may apply an NMS algorithm to the overlapping anchor boxes from the low-light image (original image) and the low-light enhancement image to detect an object (S103).

That is, the processor 130 selects an anchor box with the highest confidence among all the anchor boxes included in the low-light image (original image) and the low-light enhancement image, which results in improved object detection performance compared to applying the NMS algorithm only to the anchor boxes included in one of the low-light image (original image) and the low-light enhancement image.

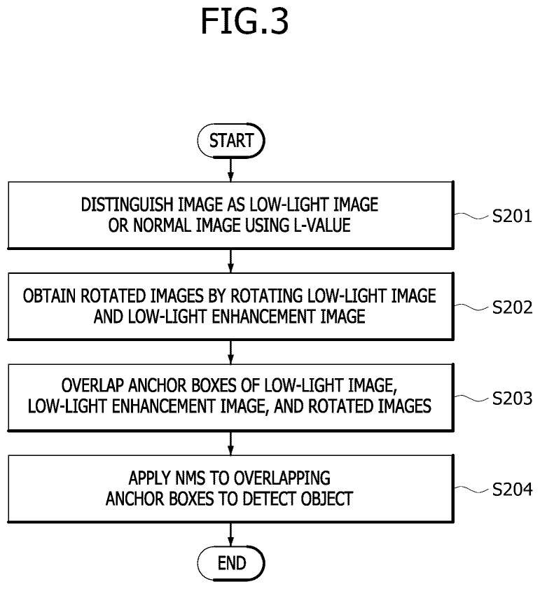

FIG. 3 is a flowchart for describing a method of detecting an object of an image according to a second embodiment of the present invention.

Referring to FIG. 3, the processor 130 uses an L-value value (i.e., a luminance value of each pixel included in the image or a value indicating whether the number of pixels corresponding to low-luminance is greater than or equal to a threshold value) to distinguish whether the input image is a low-light image or a normal image (S201).

The processor 130 obtains (generates) rotated images by rotating the low-light image (original image) and the low-light enhancement image (S202).

For reference, depending on the characteristics of the object, the orientation of the object included in the training data may have a tendency. For example, when the object is a person, the training data is likely to include a standing person. Therefore, when an image including a lying person is input to a model trained based on the training data, the probability of object detection may decrease.

Therefore, in the present embodiment, in order to improve the probability of object detection that may decrease when the orientation of the object has a tendency, not only the anchor boxes of each image (e.g., the anchor box of the low-light image and the anchor box of the low-light enhancement image) but also the anchor boxes of the rotated images for each image (e.g., the rotated image of the low-light image and the rotated image of the low-light enhancement image) are overlapped to detect the object.

That is, the processor 130 overlaps not only the anchor boxes of each image (e.g., the anchor box of the low-light image and the anchor box of the low-light enhancement image) but also the anchor boxes of the rotated images for each image (e.g., the rotated image of the low-light image and the rotated image of the low-light enhancement image) (S203), and applies the NMS algorithm to the overlapping anchor boxes to detect an object (S204).

For reference, in order to overlap the anchor boxes of the low-light image (i.e., the original image) or the anchor boxes of the low-light enhancement image and the anchor box of the rotated image generated through the second image processor 150, the processor 130 may apply, to the anchor box, a reverse rotation direction and a reverse rotation angle with respect to a rotation direction and a rotation angle of the rotated image.

Accordingly, the present embodiment has an effect of improving the object detection performance for the low-light image.

In addition, the present embodiment is implemented to overlap anchor boxes of a low-light image (original image) and anchor boxes of a plurality of images obtained by image-processing the low-light image (original image), and then applies the NMS algorithm to the overlapping anchor boxes at one time to detect an object, that is, perform a single NMS algorithm on the overlapping anchor boxes such that an anchor box with the highest confidence for a specific object is selected, and thus has an effect of improving the object detection performance in low-light images.

As described above, the present embodiment is implemented to apply a single NMS algorithm, unlike the conventional method, and thus has an effect of reducing the complexity of the algorithm, and also, even when the original image is a low-light image, applies the NMS algorithm to overlapping anchor boxes of a plurality of images that are obtained by image-processing the low-light image (original image), and thus has an effect of improving the object detection performance.

According to one aspect of the present invention, the present invention can improve the performance of object detection by detecting an object after overlapping anchor boxes of a plurality of images obtained by image processing an original image.

What is claimed is:

1. An apparatus for detecting an object of an image, the apparatus comprising:
an image classification module that distinguishes an input image as a low-light image or a normal image based on a specified criterion; and
a processor that overlaps anchor boxes of a plurality of images generated by performing at least one image process on an original image, which is a low-light image distinguished by the image classification module, and then performs an object detection algorithm on the overlapping anchor boxes.

2. The apparatus of claim 1, wherein the processor, in order to distinguish whether the input image is a low-light image or a normal image, distinguishes whether the input image is a low-light image or a normal image based on a luminance value of each pixel included in the input image through the image classification module.

3. The apparatus of claim 1, wherein the image classification module distinguishes the low-light image from the normal image according to whether the number of pixels designated as low-luminance in the input image is greater than or equal to a threshold value.

4. The apparatus of claim 1, wherein the processor, in order to overlap the anchor boxes, generates anchor boxes for a low-light enhancement image generated by applying a low-light enhancement algorithm to the original image.

5. The apparatus of claim 1, wherein the processor, in order to overlap the anchor boxes, generates anchor boxes for rotated images of the original image and the low-light enhancement image of the original image.

6. The apparatus of claim 1, wherein the processor, in overlapping the anchor boxes, generates anchor boxes of the original image, the low-light enhancement image of the original image, and the rotated images for the original image and the low-light enhancement image of the original image, and overlaps the generated anchor boxes.

7. The apparatus of claim 6, wherein the processor, in order to overlap the anchor boxes of the rotated image, applies, to the anchor boxes, a reverse rotation direction and a reverse rotation angle with respect to a rotation direction and a rotation angle of the rotated image.

8. The apparatus of claim 1, wherein the processor overlaps the anchor boxes of the plurality of images and applies a non-maximum suppression (NMS) algorithm to the overlapping anchor boxes at one time to detect an object.

9. The apparatus of claim 8, wherein the processor selects an anchor box having a highest probability of being an object based on a degree of overlap between a plurality of overlapping anchor boxes for each image through the NMS algorithm.

10. The apparatus of claim 9, wherein the processor selects an anchor box among the plurality of overlapping anchor boxes that has an intersection of union (IoU) less than a threshold value and has a maximum confidence value.

11. A method of detecting an object of an image, the method comprising:
distinguishing, by a processor, an input image as a low-light image or a normal image based on a specified criterion; and
overlapping, by the processor, anchor boxes of a plurality of images generated by performing at least one image process on an original image, which is a low-light image, and then performing an object detection algorithm on the overlapping anchor boxes.

12. The method of claim 11, wherein, in order to distinguish whether the input image is a low-light image or a normal image, the processor distinguishes whether the input image is a low-light image or a normal image based on a luminance value of each pixel included in the input image.

13. The method of claim 11, wherein, in the distinguishing, by the processor, of the input image as the low-light image or the normal image, the processor distinguishes the low-light image from the normal image according to whether the number of pixels designated as low-luminance in the input image is greater than or equal to a threshold value.

14. The method of claim 11, wherein, in order to overlap the anchor boxes, the processor generates anchor boxes for a low-light enhancement image generated by applying a low-light enhancement algorithm to the original image.

15. The method of claim 11, wherein, in order to overlap the anchor boxes, the processor generates anchor boxes for rotated images of the original image and the low-light enhancement image of the original image.

16. The method of claim 11, wherein, in the overlapping of the anchor boxes, the processor generates anchor boxes of the original image, the low-light enhancement image of the original image, and the rotated images for the original image and the low-light enhancement image of the original image, and overlaps the generated anchor boxes.

17. The method of claim 16, wherein, in order to overlap the anchor boxes of the rotated image, the processor applies, to the anchor boxes, a reverse rotation direction and a reverse rotation angle with respect to a rotation direction and a rotation angle of the rotated image.

18. The method of claim 11, wherein, in the performing of the object detection algorithm, the processor overlaps the anchor boxes of the plurality of images and applies a non-maximum suppression (NMS) algorithm to the overlapping anchor boxes at one time, to detect an object.

19. The method of claim 18, wherein, in the performing of the object detection algorithm, the processor selects an anchor box having a highest probability of being an object based on a degree of overlap between a plurality of overlapping anchor boxes for each image through the NMS algorithm.

20. The method of claim 19, wherein, in the performing of the object detection algorithm, the processor selects an anchor box among the plurality of overlapping anchor boxes that has an intersection of union (IoU) less than a threshold value and has a maximum confidence value.
